(19) United States
(12) Patent Application Publication
(10) Pub. No.: US 2012/0180905 A1
(43) Pub. Date: Jul. 19, 2012

(54) BOX STATION

(76) Inventor: Ronald Michael Webb, Las Vegas, NV (US)

(21) Appl. No.: 13/008,699

(22) Filed: Jan. 18, 2011

(51) Int. Cl. B65B 3/12; B23P 11/00; B65D 90/02

(52) U.S. Cl. 141/98; 220/62.11; 29/428

(57) ABSTRACT

An aboveground fueling facility for storing and dispensing a combustible fluid such as gasoline includes a double-wall storage tank that is constructed and arranged to store the combustible fluid in a fire resistant tank and box. The double-wall storage tank may have a first head and a second head that act as ends of the box. The box may have paneling that is fire resistant and can withstand varying weather conditions. The double-wall storage tank may be fluidly connected to a pumping system. The aboveground fueling facility may include a collapsible canopy, among other features.

### BACKGROUND OF THE INVENTION

1. Field of the Invention

The present invention relates to an aboveground fueling or service facility or station that can be conveniently and efficiently deployed in a desired location. More specifically, the invention relates to an above ground fueling or service station comprising fuel tank-box system for containing flammable and combustible material.

2. Background Information.

Nearly all modern airports have facilities of some type for refueling. The most prevalent type of aircraft refueling facilities include a below-ground storage tank or an above ground pumping module or fueling location, or both, which is operated by an attendant much in the manner of commercial stations for automobiles.

Above-ground fueling stations have become increasingly popular and commercially available. For example, a known above-ground refueling station may include a pair of tanks which are manifolded together and are mounted on a hard surface by a skid. A remotely positioned, electrically powered dispensing unit is provided to dispense the fuel from the above-ground refueling station and an attendant is on duty to monitor the refueling transaction and to prevent leaks or spills. Other examples of innovation in the above-ground fueling stations art are evidenced by the inventor's disclosures in U.S. Pat. Nos. 4,988,020; 5,033,637; 5,305,926; 5,562,162; 6,182,710; 6,216,790; 7,296,601, which are hereby incorporated by reference as if fully set forth herein.

While the prior art has provided examples of aboveground fuel tanks, and specifically aboveground fuel tanks fluidly connected to fueling locations, there is always room for improvement.

### SUMMARY OF THE INVENTION

Although aboveground fuel tanks, specifically aboveground fuel tanks connected to fueling locations are known, the inventor has realized deficiencies with such devices and has developed improvements thereon. For example, as the world becomes more industrialized and demand for above-ground fueling stations increases, the inventor has realized a growing need to produce above-ground fueling stations in a time and cost efficient manner without sacrificing the quality (e.g., safety, structural and aesthetic quality) of the developed station. Applicant has realized these and other deficiencies of the prior art devices and has combined the below objectives in a novel manner to provide a device, method and system that provides solutions to the deficiencies of the prior art.

In accordance with an aspect of the invention, an improved aboveground system for storing combustible fluid, such as gasoline, comprises a storage tank that is constructed and arranged to store combustible fluid, a box structure substantially surrounding the storage tank, a fueling station with a pump or pumps fluidly connected to the storage tank, and a canopy extending from the box structure over at least the pumps, where the canopy is at least partially supported by a ceiling of the box structure. The double-wall storage tank may be formed by inserting a first tank of a first diameter inside a can of a second diameter. The can may comprise a first head attached to a first end of connected rings. The area of the first head has an area greater than an area of a cross-section of the connected rings. Once the first tank has been inserted into, and connected to the can, a second head is placed onto the can creating a double-wall storage tank. Angles may span at least the length of the double-wall storage tank and connect to corresponding edges of the opposed heads. Panels may be used to connect the angles and form a box surrounding the tanks. As a result, the heads of the second tank then serve a dual purpose of acting as heads of a second tank surrounding the first tank and as ends of the box at least partially enclosing the tanks (i.e., the double-wall storage tank).

An object of the invention is to provide a refueling facility that has improved manufacturing qualities, including reduced production times and production costs over existing refueling facilities.

An object of the invention is to provide a refueling facility which is effective at preventing unwanted fuel leakage; is readily deployable at a desired location; and, which does not require an attendant to effect a refueling transaction.

An object of the invention is to provide a refueling facility that is insulated to reduce loss of fuel due to vaporization.

A further object of the invention is to provide an above-ground fueling facility which is insulated against fire or extreme temperature conditions.

A further object of the invention is to provide a portable aircraft refueling facility which provides clean fuel for pumping.

A further object of the invention is to provide a portable refueling facility in which fuel is loaded and unloaded with a minimal amount of spillage.

A further object of the invention is to provide a portable refueling facility which is capable of preventing vapor loss to atmosphere, especially when the facility is filled to capacity.

A further object of the invention is to provide a refueling facility which provides a warning to a fill operator during refilling when fuel in the storage tank of the facility approaches the capacity of the storage tank.

A further object of the invention is to provide a refueling facility which provides easy and convenient access to a fueling station, yet allows the fueling station to be protected at times of non-use

The above summary of the present invention is not intended to describe each illustrated embodiment, aspect, or every implementation of the present invention. The figures and detailed description and claims that follow more particularly exemplify these and other embodiments and further aspects of the invention.

### BRIEF DESCRIPTION OF THE DRAWINGS

The invention may be more completely understood in consideration of the following description of various embodiments of the invention in connection with the accompanying drawings, in which:

FIG. 1 is a side elevation view of a box station in accordance with an aspect of the present invention.

FIG. 2 is a perspective view of a feature of the box station in accordance with an aspect of the present invention.

FIG. 3 is a side view of a feature of the box station in accordance with an aspect of the invention.

FIG. 4 is an end view of the feature of the box station of FIG. 3.

FIG. 5 is an exploded perspective view of a feature of the box station in accordance with an aspect of the invention.

FIG. 6a is a front end elevation view of a feature of the box station in accordance with an aspect of the invention.

FIG. 6b is a rear end elevation view of the feature of the box station of FIG. 6a

FIG. 7 is a side elevation view of a feature of the box station in accordance with an aspect of the invention.

FIG. 8 is a plan view of a feature of the box station in accordance with an aspect of the invention.

FIG. 9 is a back end elevation view of the box station in accordance with an aspect of the invention.

FIG. 10 is a front end elevation view of the box station in accordance with an aspect of the invention.

FIG. 11 is a front end elevation view of a feature of the box station in accordance with an aspect of the invention.

FIG. 12 is a perspective view of a feature of the box station in accordance with an aspect of the invention.

FIG. 13 is a partial cross-section taken across line 13-13 of FIG. 1.

FIG. 14 is a partial cross-section taken across line 14-14 of FIG. 1.

While the invention is amenable to various modifications and alternative forms, specifics thereof have been shown by way of example in the drawings and will be described in detail. It should be understood, however, that the intention is not necessarily to limit the invention to the particular embodiments, aspects and features described. On the contrary, the intention is to cover all modifications, equivalents, and alternatives falling within the spirit and scope of the invention and as defined by the appended claims.

### DETAILED DESCRIPTION OF THE INVENTION

Referring to FIGS. 1-14, a fueling facility 100 may have a fuel storage area S and a fueling station area F, as best seen in FIG. 1. Fuel storage area S may have fuel storage 102 that comprises a double-wall storage tank 15 within a box 150, where box 150 comprises fire-resistant side panels 52. A means for providing double-wall storage tank 15 within a box comprises a first fuel storage tank 12 within, and connected to, a second fuel storage tank 13 and surrounded by at least two panels 52 (e.g., at least two panels 52 selected from the group of top side panel 52a (optional), vertical side panel 52b, bottom side panel 52c (optional)), where heads 31, 39 of second fuel tank 13 form ends of box 150. Fueling station area F may have fuel dispensing area 104 that comprises an enclosed fuel station 60 with at least one pump 64, fire-resistant side panels 52 and at least one vertical side 51 having a roll up door 76 for securing fuel station 60 when it is not in use, as well as for other purposes.

The references to top T and bottom B, which are depicted for example in FIG. 1, are meant to be relative areas as shown and described in relation to other features of fueling facility 100. A vertical direction V-V may be the direction to and from bottom B with respect to top T. A horizontal direction H-H may be the direction generally perpendicular to the vertical direction V-V. When reference is made to a “vertical” or “horizontal” object, such reference may include a substantially vertical or horizontal direction or in a general vertical or horizontal direction, unless otherwise stated, respectively.

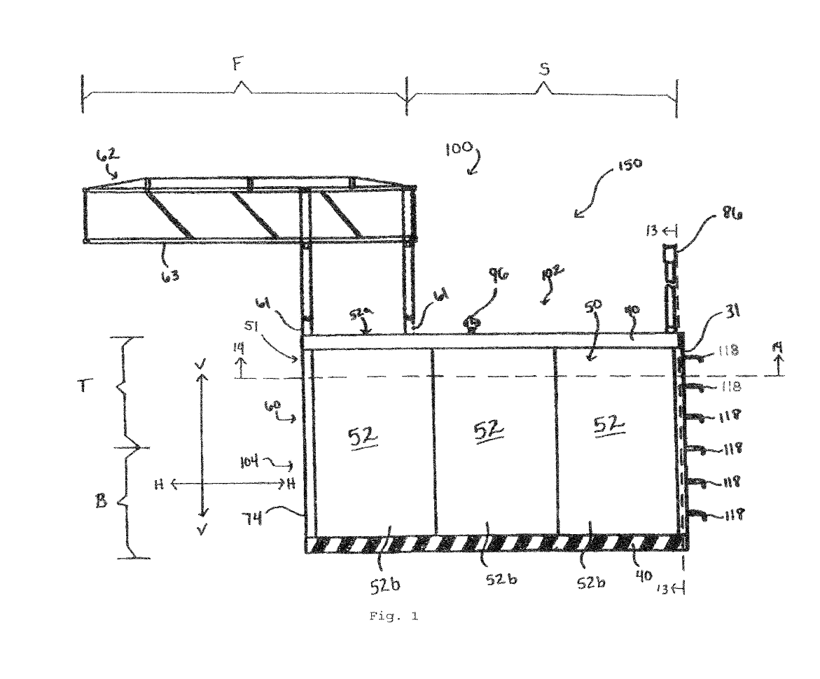

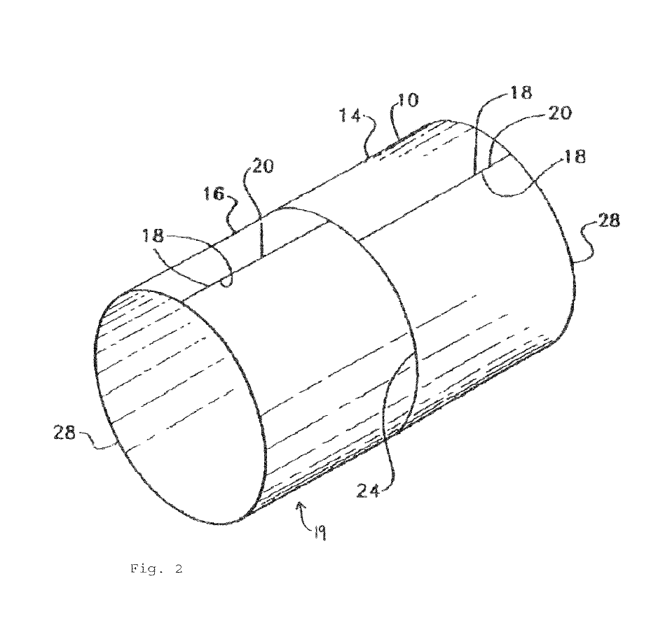

As seen in FIGS. 2-4, a cylindrical wall 10 of a first storage tank 12 may be comprised of a rolled metal sheet 14 and a rolled metal sheet 16. Both rolled metal sheets 14, 16 may be formed by cutting a rectangular piece of metal and rolling the metal until two opposite butted ends 18 come together to form a ring 19. Butted ends 18 may be welded together by a weld joint 20, or use any other connection technique capable of withstanding heat and pressure requirements of a fire-resistant tank. Rolled metal sheets 14, 16 may have an inside end 24 and outside end 28. When rolled metal sheets 14, 16 are assembled, inside ends 24 may be welded together (or connected by another connection technique forming a connection of desired strength) to form a joint. Rolled metal sheets 14, 16, and all other portions of double-wall storage tank 15, may be comprised of any material. For example, rolled metal sheets 14, 16 may be comprised of a ferrous alloy which provides fire-resistant support to first storage tank 12 (i.e., first storage tank 12 may be a fire-resistant tank). A tank may be a fire-resistant tank if it meets heat and pressure requirements that include the capability to withstand a rapid rise petroleum fire reaching 2,000 degrees Fahrenheit within five minutes of ignition for a period of two hours and remain liquid tight while withstanding an impact and rapid cooling due to a hose stream.

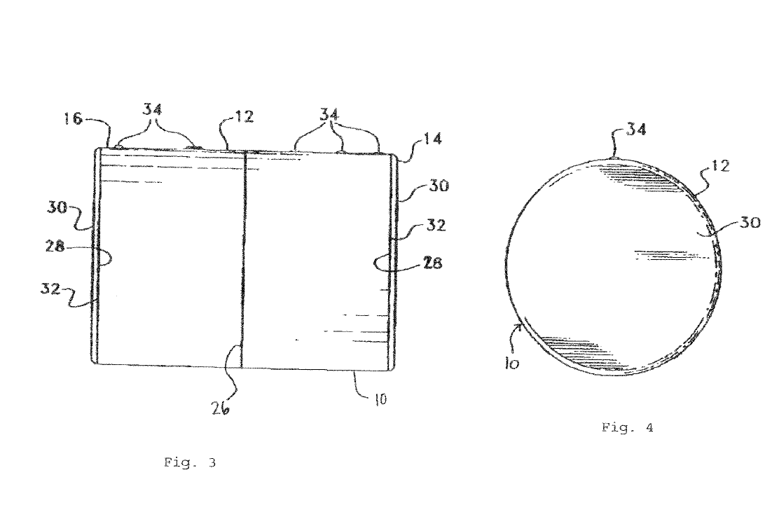

Referring to FIGS. 3 and 4, an assembled first storage tank 12 is comprised of cylindrical wall 10 and storage tank end panels or heads 30. Storage tank heads 30 may be cut from the same or different metal or material used for rolled metal sheets 14, 16. Storage tank heads 30 may be cut and attached to outside ends 28 forming joint 32. As a result of the construction and materials, formed first storage tank 12 may be a single-wall fire resistant tank or another desirable type of tank.

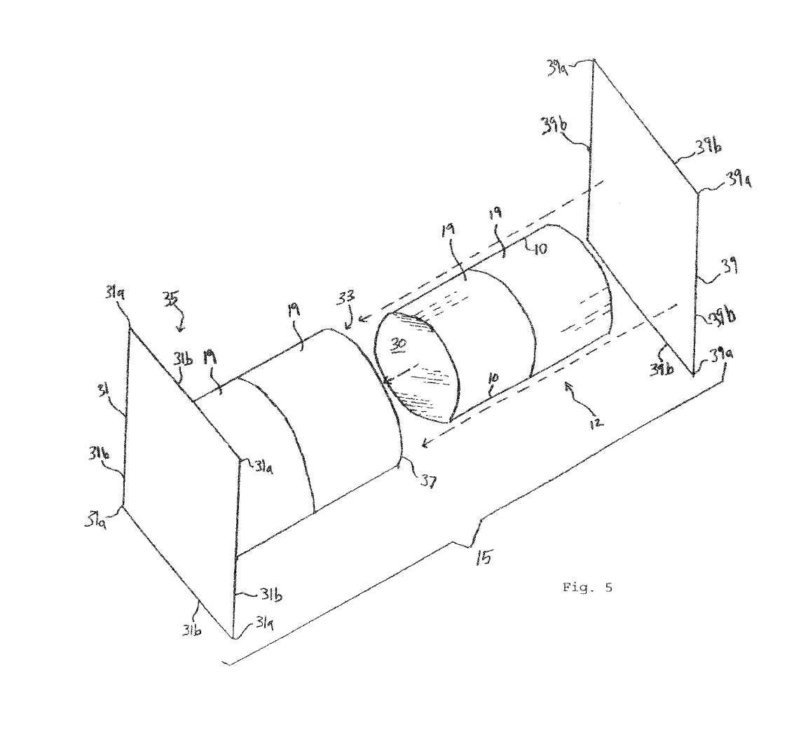

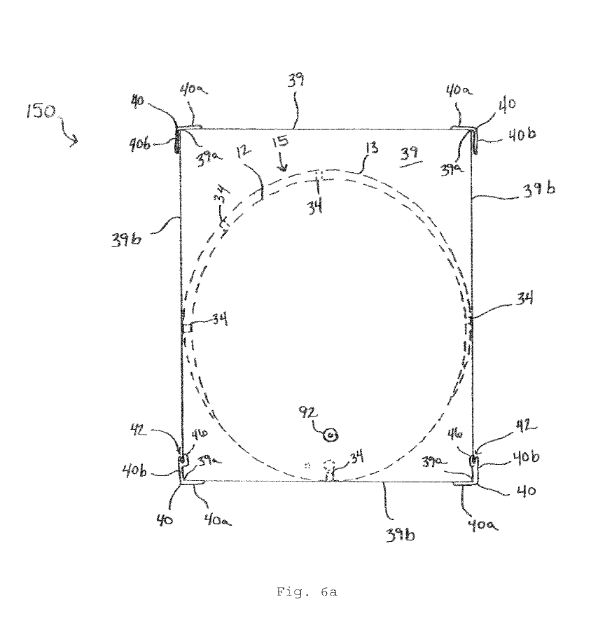

After forming first storage tank 12, additional rings 19 may be connected to one another to form a second storage tank 13 (e.g., a secondary containment tank). A single ring 19 may be utilized, or multiple rings 19 may be connected to one another. Once rings 19 have been connected to one another, an end of an open ended cylinder (not separately depicted, but shown as can 35 in FIG. 5) formed from rings 19 may be connected to a first head 31 to form a can 35 having a single opening 33, as seen in FIG. 5. First head 31 may be connected to rings 19 by any known connection technique; for example, first head 31 may be connected to rings 19 with a weld connection. As shown in FIGS. 5-6b, 9 and 10, first head 31 may be of a rectangular shape, or other shape, and have adjacent corners 31a that are connected by edges 31b spanning a distance equal to or greater than a diameter of connected rings 19 forming can 35, or first head 31 may be any other suitable shape and size. While corners 31a are depicted to be right angles, it may be appreciated that other angles greater or lesser than ninety degrees may be utilized.

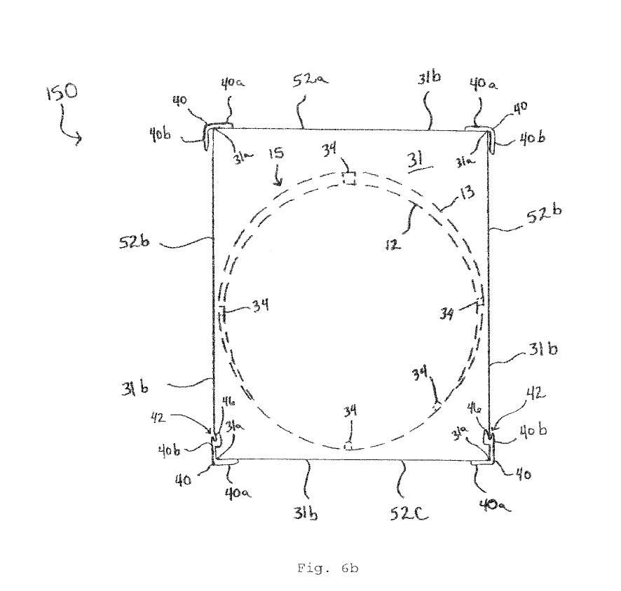

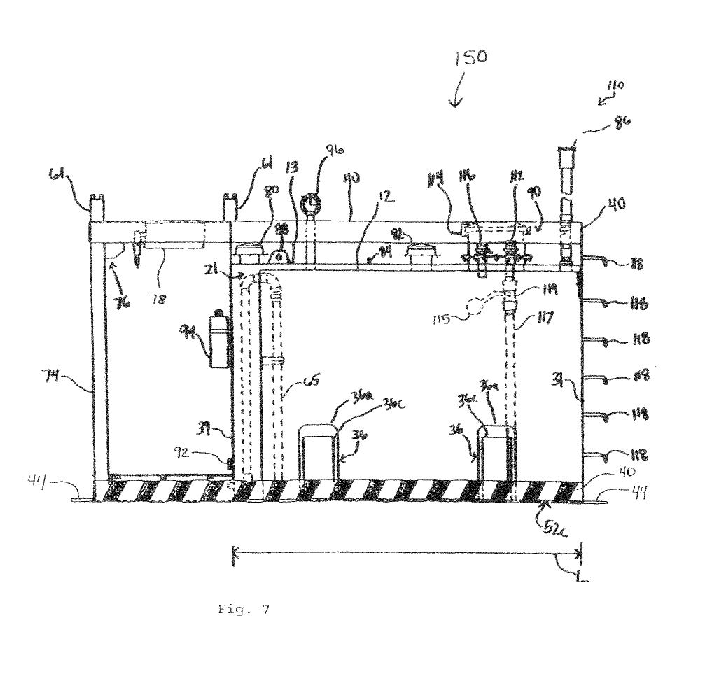

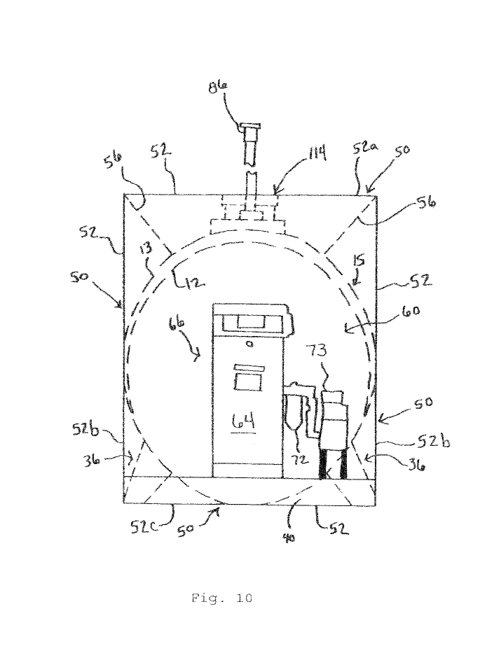

As seen in FIG. 5, after forming can 35, first storage tank 12 may be inserted into can 35, where first storage tank 12 is connected to an interior of can 35. Alternatively, second storage tank 13 may be formed around first storage tank 12 or first storage tank 12 may be inserted into and connected to the open-ended cylinder prior to forming can 35. First storage tank 12 may be connected to can 35 (or open-ended cylinder) via spacing tabs 34, which may be connected to both first storage tank 12 and can 35 through a weld connection, or any other connection technique. Interstitial spacing 21 may be left between first storage tank 12 and second storage tank 13, as seen in FIGS. 6a, 6b, and 10. One rationale for including an interstitial space 21 between first storage tank 12 and second storage tank 13 is to allow for the materials of tanks 12, 13 to expand at differing rates in the event there is a fire within or around tanks 12, 13.

Once first storage tank 12 has been connected to can 35, a second head 39 may be connected to the open end 37 of can 35 through which first storage tank 12 was inserted, as depicted by the direction arrows in FIG. 5. The connection forms a double-wall storage tank 15. Second head 39 may be substantially the same size and shape as first head 31 and fulfill the same requirements of first head 31. That is, second head 39 may be of a rectangular shape and have adjacent corners 39a that are connected by edges 39b spanning a distance equal to or greater than a diameter of rings 19 for can 35, or second head 39 may be any other suitable shape and size. Second head 39 may be connected to can 35 by any known connection technique; for example, second head 39 may be connected to can 35 with a weld connection. Heads 31, 39 may serve a dual purpose as being heads for double-wall storage tank 15 and as end pieces for box 150 (box 150 is further described below).

Double-wall storage tank 15 (e.g., a single-wall fire resistant tank inside a secondary containment tank) may be supported substantially in rest by any known device or technique, including attached heads 31, 39. For example, double-wall storage tank 15 may be supported relative to a flat horizontal surface (e.g., a ground surface of concrete) by one or more saddle members 36, as seen in FIGS. 7, 8, 10, 12 and 13. Each saddle member 36 may have at least one substantially planar lower support 36b and a concave upper support 36a which may receive a bottom portion of second storage tank 13, where lower surface 36b and upper surface 36a are structurally connected, directly or by intermediate parts.

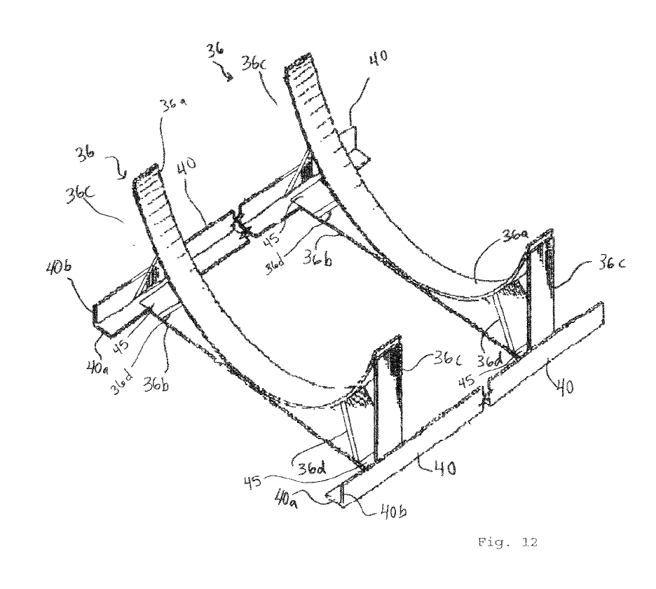

An example of a saddle member 36 is depicted in FIG. 12, where saddle 36 includes concave upper support 36a and a substantially planar lower support 36b connected by substantially planar first diagonal supports 36c and substantially planar second diagonal supports 36d. Supports 36a, 36b, 36c, 36d may be at any angle with respect to a ground level on which fueling facility 100 rests and with respect to each other so long as side panels 52 have space to abut angles 40 and to be structurally secure. Further, supports 36b, 36c, 36d may connect to angles 40 at any location. Supports 36b, 36c, 36d may be connected to angles 40 through any known connection technique; for example, supports 36b, 36c, 36d may be welded to angles 40.

For structural integrity and other purposes, at least one angle 40 may connect heads 31, 39 to at least partially form a frame of box 150. As shown in FIG. 7, angles 40 may connect and span at least a distance L separating first head 31 and second head 39 of double-wall storage tank 15. Angles 40 may be connected to heads at any location that facilitates forming sides 50 around double-wall tank 15. For example, angles 40 may connect corresponding opposite corners 31a, 39a of first head 31 and second head 39. For example, such corresponding corners 31a, 39a may include corresponding first corners, second corners, third corners and fourth corners. In one aspect box 150 may include at least two sides 50, or any number of sides 50, which at least partially enclose tank 15. In a further aspect box 150 includes sides, including heads 30, which enclose tank 15.

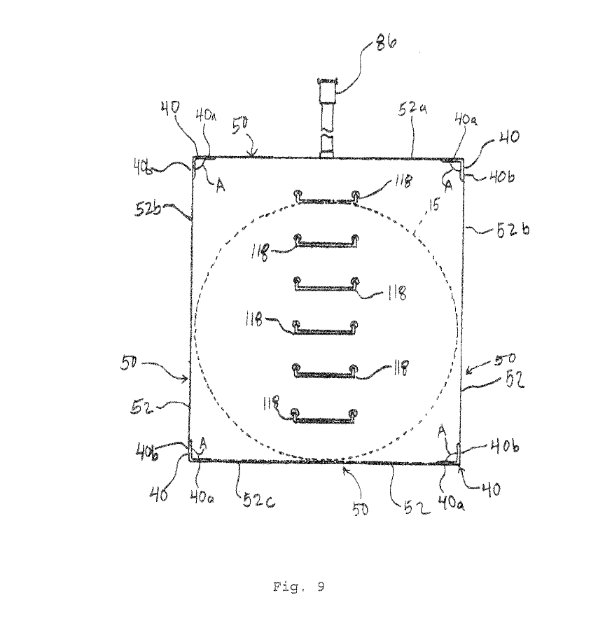

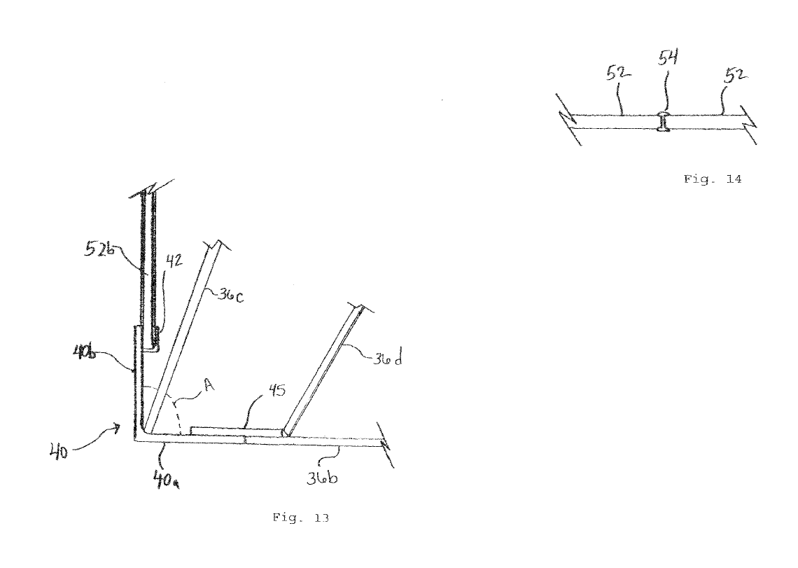

Angles 40 may be any shape that facilitates connection to heads 31, 39 and forming sides 50. In the above example, if heads 31, 39 are rectangular shapes having right-angled corners 31a, 39a as seen in FIGS. 6a, 6b and 9, angles 40 may have a first side 40a and a second side 40b separated by an angle A substantially equal to ninety degrees, as shown in FIG. 13. Such an arrangement of sides 40a, 40b may allow angles 40 to fit onto corners 31a, 39a while securely abutting panels 52. Angles 40 may be connected to heads 31, 39 by any known connection technique; for example, the connection technique may be a weld or fastener connection, a combination thereof, or another type of connection.

Angles 40 may include panel sockets 42 or reinforcing plates 45, or both, for receiving side panels 52 and support 36 (where support 36 may be welded to reinforcing plates 45), respectively, as depicted in FIG. 13. Panel sockets 42 may be capable of receiving sides 50. For example, angles 40 may have a panel socket 42 on second side 40b and a reinforcing plate 45 on a first side 40a, a panel socket 42 on both first side 40a and second side 40b, a reinforcing plate 45 on both first side 40a and second side 40b, or may have neither reinforcing plates 45 nor panel sockets 42. Angles 40, as seen in FIG. 13, may have a panel socket 42 for receiving vertical side panel 52b and reinforcing plate 45 for receiving lower support 36b. To accommodate a thickness of the material of panel socket 42, vertical edges 31 b, 39b may have notches 46, as seen in FIG. 6a, that are capable of receiving panel sockets 42.

Panel socket 42 and reinforcing plate 45 may be connected to sides 40b, 40a of angle 40 by any connection technique; for example, such connection technique may include welding. Further, panel sockets 42 may extend along angle 40 the length of sides 50 or may be made up of separate attachments along the length of sides 50. Reinforcing plates 45 may extend along angle 40 the length of sides 50 or may be made up of separate attachments along the length of sides 50.

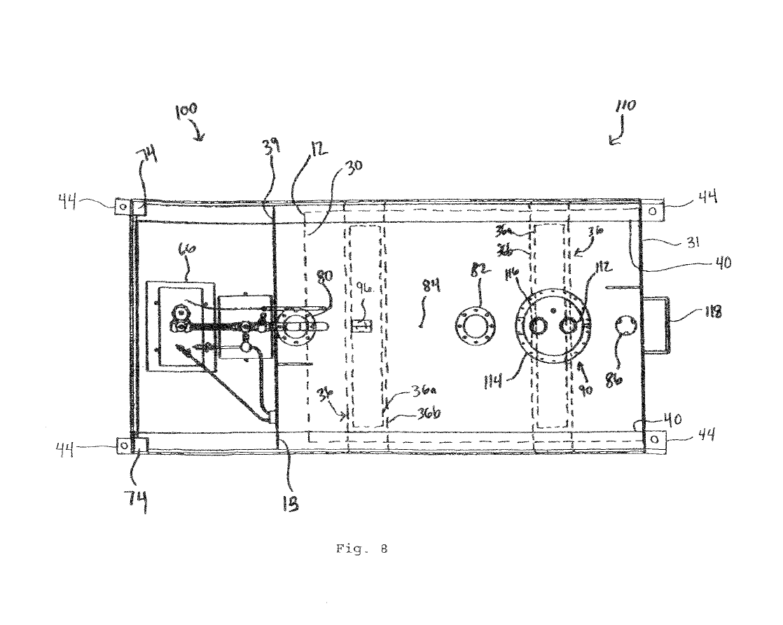

Further, angles 40 may extend past head 31 and an at least one vertical side 51 to form anchor tabs 44, as seen in FIGS. 7 and 8. Anchor tabs 44 may be used for any purpose. For example, anchor tabs 44 may be used to secure fueling facility 100 to a structure or a ground surface such that it is not blown away in high winds, is not carried away in the event of a flood, and does not tip over during an earthquake.

To support angles 40 above double-wall storage tank 15, structural braces 56 may extend from an exterior surface of second storage tank 13 to a meeting point of first and second sides 40a, 40b of angle 40, as shown in FIG. 10. Structural braces 56 may have a curved portion in contact with the exterior surface of second storage tank 13 and extensions extending from the curved portion that extend to the meeting point of first and second sides 40a, 40b (e.g., a corner). Optionally, there may be no curved portion of brace 56 such that extensions provide support by extending from the meeting point of first and second sides 40a, 40b to the exterior of second storage tank 13. There may be any number of support braces 56 along angles 40 and second storage tank 13 so as to provide support for at least angles 40 and a top side panel 52a. Top side panel 52a may also be at least partially supported by heads 31, 39 and other supports.

Panels 52 may be inserted into adjacent angles 40 with a slide fit or another connection technique. Adjacent angles 40 may be any set of two angles 40 connecting sequential corresponding corners 31a, 39a when traversing around double-wall storage tank 15. Panels 52 may have a length substantially equal to the distance or length L between heads 31, 39 or any other length. Panels 52 may be shorter than distance L as shown in FIG. 1, and if so, a conjunctive H-channel 54 may be used to support sequential panels 52 forming a side 50, as seen in FIG. 14. Panels 52 may be connected to H-channel 54, angles 40, heads 31, 39 and other objects which panels may contact by any known connection technique including, but not limited to, a slide fit, a pressure fit, a fastening connection (e.g., a nut and bolt connection or a tie connection) or other connection.

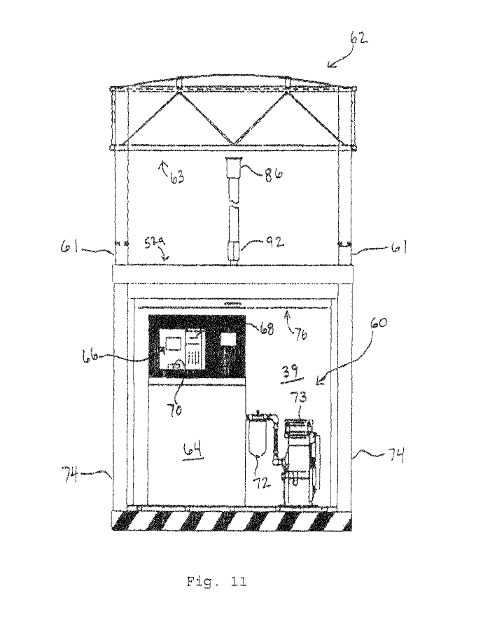

As shown in FIG. 1, angles 40 and panels 52 may extend past a location of second head 39 (second head is not depicted in FIG. 1) so as to provide framing and sides for a fueling station area F enclosing fueling station 60 and on which canopy 62 may be supported. For example, angles 40 may extend through at least fueling station 60 to support posts 74. Panels 52 may be inserted into angles 40 so as to form at least vertical walls on the side of fueling station, along with a top cover. Instead of a panel 52 for an end vertical wall covering access to first pump 64 of fueling station 60, a roll up door 76 may be utilized, as seen in FIG. 11.

Panels 52 may be made of any material suitable for surrounding a fuel storage tank. An example of such a material may include a corrugated/fluted copolymer plastic core having laminated aluminum overlays on both sides of the corrugated/flute copolymer plastic. This material may be commercially available under the trademark ALUMACORR offered by NUDO Products, Inc. Panels 52 may provide protection to double-wall storage tank 15 from external weather variations in that panels 52 provide insulation for double-wall storage tank 15 that reduces vaporization of fuels within tank 15.

As seen in FIGS. 6a-11, fueling facility 100 may distribute fuel from double-wall storage tank 15 to fueling station 60 by any known pumping system. For example, a first pump 64 may draw fuel from double-wall storage tank 15 through a supply pipe 65. Fueling facility 100 may have several other features to facilitate safe and efficient use of facility 100. For example, in addition to double-wall storage tank 15, fueling facility 100 may include an interstitial emergency vent 80, product emergency vent 82, interstitial test port 84, working vent (with alarm) 86, manway 90, interstitial sight gauge 92, fire extinguisher 94, fire suppression system 78, clock gauge 96 and other features. Interstitial sight gauge 92 may be utilized for visually indicating and visual monitoring of leaks of first (internal) storage tank 12. Further, double-wall storage tank 15 may include lift lugs 88 connected to the exterior surface of second storage tank 13 for the purpose of facilitating transfer and movement of double-wall storage tank 15.

Fueling station 100 may have several set-ups for filling double-wall storage tank 15 with fuel. An example may be a top fill system 110, seen in FIGS. 7-11. Top fill system 110 may be filled from a top side T of double-wall storage tank 15 through the use of top fill port 112, top fill manway 114, top stage-one vapor recovery 116, fill pipe 117 extending from a bottom to a top of first storage tank 12 and overfill prevention valve 119, along with a ball float and arm 115, located at or near a position where fill pipe 117 exits first storage tank 12. Further, top fill system 110 may include ladder rungs 118 providing access to a top of fueling station 100. Rungs 118 may extend from a head 31 or 39 at an end of double-wall storage tank 15.

Fueling facility 100 may include a fueling station 60, which may have a protective collapsible canopy 62 and at least a first pump 64, where pump 64 may be covered by canopy 62 or top side panel 52a, or both, as seen in FIGS. 1 and 11. Canopy 62 may be strong enough to support solar panels, other alternative energy source collection devices, signage or other objects Further, canopy 62 may extend at least from an area above double-wall storage tank 15 to an area adjacent pump 64 on a side of pump 64 opposite a side where double-wall storage tank 15 is located. Operation of pump 64 may be controlled by a pump control unit 66. To facilitate self-service refueling, shown in FIG. 11, a credit card reader 68 may be provided in fueling station 60. Further, a receipt printer 70 may be located adjacent credit card reader 68 for the purpose of optionally providing a tangible verification of the refueling transaction.

Canopy supports 61 may extend from a top side of angles 40 at locations generally above fueling station 60. Canopy supports 61 may connect to canopy frame 63 and canopy 62 may be formed about canopy frame 63 so as to extend from fueling station 60 to an area adjacent fueling station 60 opposite a side of double-wall storage tank 15, as seen in FIGS. 1 and 11.

In operation, first pump 64 when activated, may pump fuel from double-wall storage tank 15 through a filter 72 into hose real system 73 having a first hose and a nozzle which may be held by an operator during the refueling process. A user of facility 100 may be able to monitor the amount of fuel dispensed via pump control unit 66. Further, the user may be able to pay for the dispensed fuel via credit card reader 68 and receive a receipt verification of the transaction via receipt printer 70.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise specifically indicated. While the particular BOX STATION as herein shown and described in detail is fully capable of attaining the above-described aspects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

What is claimed is:

1. An apparatus, comprising:
a box;
a double-wall tank;
a first head; and
a second head,
where said first head and said second head serve dual purposes of being heads at opposite ends of said double-wall tank and as end pieces of said box.

2. The apparatus of claim 1, further comprising:
a top panel, and
where said first head and said second head support said double-wall tank and said top panel.

3. The apparatus of claim 2, further comprising:
a collapsible canopy connected to said top panel.

4. The apparatus of claim 1, further comprising:
removable panels forming sides of said box.

5. The apparatus of claim 4, further comprising:
said removable side panels are fire resistant.

6. The apparatus of claim 1, further comprising:
an interstitial sight gauge extending from said double-wall tank; and
said double-wall tank, comprising:
an external storage tank; and
an internal storage tank internal to said external storage tank,
where said interstitial sight gauge allows for visual indication of leaks in said internal storage tank.

7. The apparatus of claim 1, further comprising:
said double-wall tank has a substantially horizontal length.

8. An apparatus, comprising:
a fuel storage area comprising a horizontal tank at least partially surrounded by a fire resistant box;
a fuel dispensing area extending from said fuel storage area;
side panels surrounding at least two sides of said fuel dispensing area.

9. The apparatus of claim 8, further comprising:
a fire suppression system within said fuel dispensing area.

10. The apparatus of claim 8, further comprising:
said horizontal tank is a fuel storage tank;
a fueling station in said fuel dispensing area, comprising:
a pump fluidly connected to said fuel storage tank, and where said fueling station may be enclosed within said dispensing area by a rollup door.

11. The apparatus of claim 8, further comprising:
said fuel storage area is substantially aboveground; and
said fuel dispensing area is substantially aboveground.

12. The apparatus of claim 8, further comprising:
said horizontal tank comprises:
a horizontal single-wall fire resistant tank inside a secondary containment tank.

13. A method of forming a fueling facility, comprising:
providing a first tank having a first diameter;
providing a can having a second diameter and said can having an open end and an end connected to a first head having a length greater than the second diameter;
inserting the first tank into the can; and
attaching a second head to the can to form a double-wall fuel tank.

14. The method of claim 13, further comprising:
connecting the first tank to an interior of the can.

15. The method of claim 13, further comprising:
where the first head has a first corner; and
where the second head has a first corner.

16. The method of claim 15, further comprising:
connecting an angle to the first head and the second head, and
where the angle spans from the first corner of the first head to the first corner of the second head.

17. The method of claim 13, further comprising:
where the first head and the second head have corresponding first corners, second corners, third corners and fourth corners, and
spanning an angle between the corresponding corners.

18. The method of claim 17, further comprising:
inserting a panel between a first set of adjacent angles.

19. The method of claim 18, further comprising:
inserting panels between all adjacent angles, and
where the panels form walls of a box surrounding the double-wall fuel tank and the first head and the second head form ends of the box.

20. The method of claim 13, further comprising:
connecting a pump to the double-wall fuel tank.
